(19) United States
(12) Patent Application Publication
(10) Pub. No.: US 2006/0262707 A1
(43) Pub. Date: Nov. 23, 2006

(54) Objective lens and optical pickup apparatus using the same

(75) Inventors: Mitsuhiro Miyauchi, Ibaraki-shi (JP); Koichiro Wakabayashi, Ibaraki-shi (JP); Yasuyuki Sugi, Ibaraki-shi (JP); Yutaka Makino, Ibaraki-shi (JP)

Correspondence Address: OLIFF & BERRIDGE, PLC, P.O. BOX 19928, ALEXANDRIA, VA, 22320, US

(73) Assignee: Hitachi Maxell, Ltd., Ibaraki-shi (JP)

(21) Appl. No.: 11/434,212

(22) Filed: May 16, 2006

(30) Foreign Application Priority Data
May 18, 2005 (JP) 2005-145902

(51) Int. Cl. G11B 7/135

(52) U.S. Cl. 369/112.01

(57) ABSTRACT

A lens surface of an objective lens is divided into a plurality of zones concentric about an optical axis. The lens surface includes an inner area and an outer area located outside the inner area. The inner area focuses the first light beam on the information recording surface of the first optical recording medium and focuses the second light beam on the information recording surface of the second optical recording medium. The outer area causes the first light beam to become flare and focuses the second light beam on the information recording surface of the second optical recording medium.

### BACKGROUND OF THE INVENTION

1. Field of the Invention

The present invention relates to an objective lens and an optical pickup apparatus using the same which can be used for a compatible recording and reproduction apparatus that is compatible with different types of optical recording media such as compact disk (CD), digital versatile disk (DVD), high definition digital versatile disk (HD DVD) and Blu-ray.

2. Description of Related Art

Compatible optical disk apparatus capable of recording and/or reproducing different types of optical disks such as CD and DVD in one system have been proposed and in practical use. The recording density of an optical disk depends on an light spot diameter that is focused on an information recording surface. The light spot diameter is proportional to λ/NA where λ is a wavelength of a light source and NA is a numerical aperture of an objective lens on image side. Accordingly, the wavelength of a light source, NA of an objective lens and the thickness of a transparent substrate which are used in an optical disk apparatus differ between CD and DVD.

Therefore, a compatible optical disk apparatus for recording and reproducing different kinds of optical disks should be designed in light of the following points:

(1) To correct spherical aberration occurring due to a difference in thickness of transparent substrates and/or chromatic aberration occurring due to a difference in wavelength of light sources; and

(2) To change NA so as to obtain an light spot suitable for recording and reproduction of information on each optical disk.

An approach for achieving such a compatible optical disk apparatus is to use objective lenses for different types of optical disks in a pickup and change the objective lenses in accordance with the type of the optical disk in use, or to use pickups for different types of optical disks and change the pickups in accordance with the type of the optical disk in use. However, in terms of cost and size reduction, it is preferred to use the same objective lens for any type of optical disk.

An example of such an objective lens is disclosed in Japanese Unexamined Patent Publication No. 2000-81566. It discloses an optical disk apparatus that uses a light beam having a short wavelength (635 nm or 650 nm) for DVD with a thinner transparent substrate and uses a light beam having a long wavelength (780 nm) for CD with a thicker transparent substrate. This optical disk apparatus includes an objective lens that is used in common for these light beams. The objective lens has a diffractive lens structure with a plurality of minute loop zonal steps thickly formed on one side of a refractive lens having a positive refractive power. The diffractive lens structure is designed so as to focus diffracted light of a beam having a short wavelength on the information recording surface of a DVD with a thinner transparent substrate, and focus diffracted light of a beam having a long wavelength on the information recording surface of a CD with a thicker transparent substrate. Further, it is designed so as to focus the diffracted light having the same diffractive order on the information recording surface.

However, since the objective lens disclosed in the above patent document uses diffracted light by the diffractive lens structure, it is unable to realize the diffraction efficiency of 100% for each of different wavelengths at the same time. The diffraction lens disclosed in the above patent document is designed so that a diffraction efficiency reaches 100% at a light beam having an intermediate wavelength between a light beam with a short wavelength (substantially 650 nm) used for DVD and a light beam with a long wavelength (substantially 780 nm) used for CD so as to balance the diffraction efficiency for the light beams in use. Not reaching the diffraction efficiency of 100% means not capable of focusing all incident light beams on an information recording surface of a transparent substrate of an optical disk, which results in light loss.

Recently, a high-density optical disk that uses a blue laser having a still shorter wavelength has been proposed and in practical use. The high-density optical disc has a transparent substrate whose thickness is equal to or less than that of DVD. HD DVD is one type of the high-density optical disk. For the achievement of compatibility among HD DVD, DVD and CD, the following problems exist:

(1) Because the usable light wavelengths are extended to about 400 nm to 790 nm, it is more difficult to obtain high diffraction efficiency for each of HD DVD, DVD and CD in the diffraction lens structure of the objective lens disclosed in the above-described Japanese Unexamined Patent Publication No. 2000-81566. Consequently, it is unable to achieve high light use efficiency for any of HD DVD, DVD and CD.

(2) Because a higher NA (NA=about 0.63 to 0.65) is set for recording DVD in order to ensure sufficient light intensity, and a focal length of an objective lens differs between HD DVD (NA=0.65) and DVD (NA=about 0.63 to 0.65), the effective diameter is larger for DVD with a longer wavelength than HD DVD with a shorter wavelength. As disclosed in Japanese Unexamined Patent Publication No. 2004-219474, a conventional compatible technique between DVD and CD, for example, is such that an effective diameter for a disk with a shorter wavelength, which is DVD in this case, is larger, and thus requires aperture limitation for a disk with a longer wavelength, CD. However, in order to realize compatibility with an optical disk having a still shorter wavelength, i.e. HD DVD and DVD, in this technique, it is sometimes necessary to impose the aperture limitation for a disk with a shorter wavelength.

As described in the foregoing, a conventional objective lens has a problem that it is difficult to focus light beams on an information recording surface of a plurality of disks of optical disks which uses different wavelengths with appropriate NA and high light use efficiency.

### SUMMARY OF THE INVENTION

In view of the foregoing, it is an object of the present invention to provide an objective lens that is capable of focusing a light beam on an information recording surface of each of different kinds of optical disks using different use wavelengths with appropriate NA and high light use efficiency and an optical pickup apparatus using the objective lens.

To these ends, according to an aspect of the present invention, there is provided an objective lens that focuses a first light beam with a wavelength λ1 on an information recording surface of a first optical recording medium and focuses a second light beam with a wavelength λ2 being longer than the wavelength λ1 on an information recording surface of a second optical recording medium. At least one lens surface is divided into a plurality of ring-shaped zones concentric about an optical axis and includes an inner area composed of a part of the plurality of zones and including the optical axis and an outer area composed of a part of the plurality of zones and located outside the inner area. The inner area focuses the first light beam on the information recording surface of the first optical recording medium and focuses the second light beam on the information recording surface of the second optical recording medium. The outer area causes the first light beam to become flare and focuses the second light beam on the information recording surface of the second optical recording medium.

In the above objective lens, each of the plurality of zones preferably has a different aspherical shape. It is also preferred that the light beam with the wavelength λ1 and the light beam with the wavelength λ2 are incident on the objective lens with a substantially same diameter. The light beam with the wavelength λ1 and the light beam with the wavelength λ2 may be incident on the objective lens in substantially parallel or may be incident on the objective lens as convergent light beams.

Preferably, the objective lens has a positive power to focus each light beam by refraction.

It is further preferred that, in the above objective lens, a difference in optical path length between a ray of the light beam with the wavelength λ1 passing through a ring shaped zone in the inner area and a ray of the light beam with the wavelength λ1 passing through an adjacent ring-shaped zone in the inner area is substantially 2mλ1 where m is an integral number, and a difference in optical path length between a ray of the light beam with the wavelength λ2 passing through a ring-shaped zone in the inner area and a ray of the light beam with the wavelength λ2 passing through an adjacent ring shaped zone in the inner area is substantially 2nλ2 where n is an integral number.

In addition, if a third light beam with a wavelength λ3 (λ1<λ2<λ3) is incident as divergent light, the third light beam is preferably focused on an information recording surface of a third optical recording medium.

In a preferred embodiment, the wavelength λ1 is substantially 405 nm, the wavelength λ2 is substantially 660 nm, and the wavelength λ3 is substantially 785 nm. Further, an effective diameter for the first light beam is preferably smaller than an effective diameter for the second light beam.

According to another aspect, there is provided an objective lens that focuses a first light beam with a wavelength λ1 on an information recording surface of a first optical recording medium and focuses a second light beam with a wavelength λ2 being longer than the wavelength λ1 on an information recording surface of a second optical recording medium, and focuses a third light beam with a wavelength λ3 being longer than the wavelength λ2 on an information recording surface of a third optical recording medium. At least one lens surface is divided into a plurality of ring-shaped zones concentric about an optical axis and including a first inner area composed of a part of the plurality of zones and including the optical axis and a second inner area composed of a part of the plurality of zones and located outside the first inner area. The first inner area focuses the first light beam on the information recording surface of the first optical recording medium, focuses the second light beam on the information recording surface of the second optical recording medium, and focuses the third light beam on the information recording surface of the third optical recording medium. The second inner area focuses the first light beam on the information recording surface of the first optical recording medium and focuses the second light beam on the information recording surface of the second optical recording medium. The outer area causes the first light beam to become flare and focuses the second light beam on the information recording surface of the second optical recording medium. The third light beam passes through the second inner area. The outer area is controlled not to be focused on the information recording surface of the third optical recording medium.

According to another aspect, there is provided an optical pickup apparatus including a first laser for emitting a first light beam with a wavelength λ1, a second laser for emitting a second light beam with a wavelength λ2 being longer than the wavelength λ1, and an objective lens for focusing the first light beam emitted by the first laser on an information recording surface of a first optical recording medium and focusing the second light beam emitted by the second laser on an information recording surface of a second optical recording medium. At least one lens surface of the objective lens is divided into a plurality of ring-shaped zones concentric about an optical axis and includes an inner area composed of a part of the plurality of zones and including the optical axis and an outer area composed of a part of the plurality of zones and located outside the inner area. The inner area focuses the first light beam on the information recording surface of the first optical recording medium and focuses the second light beam on the information recording surface of the second optical recording medium. The outer area causes the first light beam to become flare and focuses the second light beam on the information recording surface of the second optical recording medium.

In the above optical pickup apparatus, each of the plurality of zones on the objective lens preferably has a different aspherical shape. It is also preferred that the optical pickup apparatus further includes a third laser for emitting a third light beam with a wavelength λ3 (λ1<λ2λ3) incident on the objective lens as divergent light, and the objective lens focuses the third light beam on an information recording surface of a third optical recording medium.

The present invention provides an objective lens that is capable of focusing a light beam on an information recording surface of each of different kinds of optical disks using different use wavelengths with appropriate NA and high light use efficiency and an optical pickup apparatus using the objective lens.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a schematic view showing the front side and cross-section of an objective lens according to an embodiment of the present invention;

FIG. 2 is a schematic view showing the structure of an optical pickup apparatus according to Example 1;

FIG. 3 is a view showing spherical aberration of the objective lens according to Example 1 for HD DVD;

FIG. 4 is a view showing spherical aberration of the objective lens according to Example 1 for DVD;

FIG. 5 is a view showing wavefront aberration of the objective lens according to Example 1 for HD DVD;

FIG. 6 is a view showing wavefront aberration of the objective lens according to Example 1 for DVD;

FIG. 7 is a view showing an light spot on the objective lens according to Example 1 for HD DVD;

FIG. 8 is a view showing an light spot on the objective lens according to Example 1 for DVD;

FIG. 9 is a schematic view showing the structure of an optical pickup apparatus according to Example 2;

FIG. 10 is a front view of an example of an aperture limiting element used in Example 2;

FIG. 11 is a view showing spherical aberration of the objective lens according to Example 2 for HD DVD;

FIG. 12 is a view showing spherical aberration of the objective lens according to Example 2 for DVD;

FIG. 13 is a view showing spherical aberration of the objective lens according to Example 2 for CD;

FIG. 14 is a view showing wavefront aberration of the objective lens according to Example 2 for HD DVD;

FIG. 15 is a view showing wavefront aberration of the objective lens according to Example 2 for DVD;

FIG. 16 is a view showing wavefront aberration of the objective lens according to Example 2 for CD;

FIG. 17 is a view showing an light spot on the objective lens according to Example 2 for HD DVD;

FIG. 18 is a view showing an light spot on the objective lens according to Example 2 for DVD;

FIG. 19 is a view showing an light spot on the objective lens according to Example 2 for CD;

FIG. 20 is a schematic view showing the structure of an optical pickup apparatus according to Example 3;

FIG. 21 is a view showing spherical aberration of the objective lens according to Example 3 for HD DVD;

FIG. 22 is a view showing spherical aberration of the objective lens according to Example 3 for DVD; and

FIG. 23 is a view showing spherical aberration of the objective lens according to Example 3 for CD.

### DESCRIPTION OF THE PREFERRED EMBODIMENTS

An embodiment of the present invention is described hereinafter in detail.

It is assumed that, in an optical disk apparatus, aberration of an objective lens is appropriately corrected for a first optical disk with a transparent substrate having a thickness t₁ so that a light beam having a wavelength λ₁ is appropriately focused on an information recording surface of the transparent substrate. In this optical disk apparatus, a light beam having a wavelength λ₂, which is different from the wavelength λ₁, cannot be suitably focused on an information recording surface of the transparent substrate having a thickness t₂ of a second optical disk. This is because, due to the difference between the light beam wavelength λ₁ and λ₂ and the difference between the transparent substrate thickness t₁ and t₂ or due to the difference between the wavelength λ1 and λ₂ even when the thickness t₁ and t₂ are the same, the objective lens undergoes both spherical aberration caused by the difference in substrate thickness and chromatic aberration caused by a difference in refractive index of the objective lens due to the difference in wavelength or only the chromatic aberration.

The objective lens of the present invention has an aspherical surface whose shape is designed so that each optical path length at a given beam height is such that no or almost no aberration occurs for different kinds of disks, thereby achieving appropriate correction in aberration for each optical disk. This invention realizes the correction of aberration by using refracted light only, without using diffraction; therefore, light loss due to diffraction does not occur.

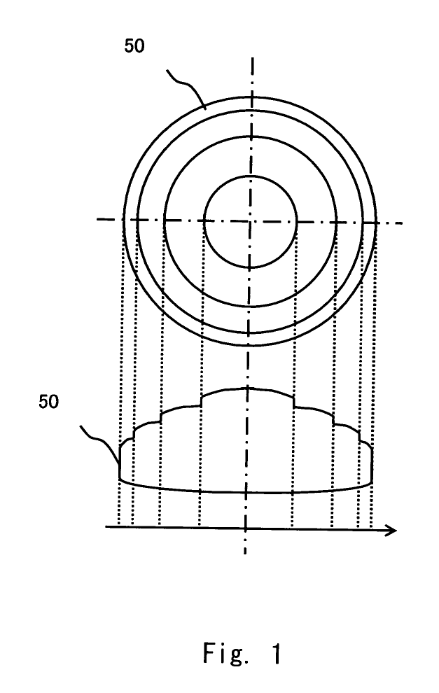

FIG. 1 is a view showing the configuration of an objective lens 50 according to an embodiment of the present invention. It shows the front side and the cross-section of the objective lens 50 in the upper part and the lower part, respectively. As illustrated in FIG. 1, at least one lens surface of the objective lens 50 has at least two loop zones having predetermined depth d, height h and a specific aspherical shape which are formed radially and concentrically about the optical axis. It further has an inner area which includes the optical axis and is composed of one or more loop zones, and an outer area which is located outside the inner area and composed of one or more loop zones.

The aspherical shape of each loop zone in the inner area is optimized so as to reduce wavefront aberration for both wavelength λ1 and λ₂. In the present invention, the “aspherical shape” can be expressed as Expression 1 below, where Zj(h) represents a distance (sag amount) from a tangent plane on the optical axis of the aspherical surface at a coordinate point on the aspherical surface having a height h from the optical axis, C represents a curvature (1/curvature radius) on the optical axis of the aspherical surface, K represents a conic coefficient, A4, A6, A8, A10, A12, A14 and A16 represent fourth-order to sixteenth-order aspherical coefficients, and B represents a constant.
Expression 1:

$${Z}_{j} ( h ) = \frac{{Ch}^{2}}{1 + \sqrt{1 - ( K + 1 ) {C}^{2} \cdot {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16} + B$$

Reduction in wavefront aberration means to reduce wavefront aberration within ±0.14λi or ±0.13λi being more preferable for light beams passing through any of the loop zones.

A step height d between adjacent loop zones is expressed as d˜m*λ1/(n1−1) where m represents a natural number, and n1 represents a refractive index of the objective lens at wavelength λ1.

The aspherical surface shape of each loop zone in the outer area of the objective lens 50 is optimized so as to reduce wavefront aberration for the light beam having either one of the wavelengths λ1 and λ2. For example, if the aspherical surface is optimized so as to reduce wavefront aberration for the light beam having the wavelength λ2, the light beam having the wavelength λ2 is focused, but the light beam having the wavelength λ1 which has passed through the outer area causes large spherical aberration and become “flare”, without being focused. Accordingly, if the light beam having the wavelength λ1 passes through the objective lens of this embodiment, only the light beam having passed through the inner area is focused. Therefore, the objective lens serves also as an aperture limiter for the light beam having the wavelength λ1. Whether the light beam having the wavelength λ1 after passing through the outer area becomes flare or not can be verified as follows. First, a mechanical diaphragm to cause the light beam having the wavelength λ1 to enter only the inner area without entering the outer area is placed, and a spot diameter and aberration of the light after passing through the objective lens are measured. Then, the spot diameter and aberration is measured without the mechanical diaphragm, which is when the light beam having the wavelength λ1 enters both the outer area and the inner area. If the light beam having the wavelength λ1 after transmitting through the outer area is flare, the light after passing through the outer area is not substantially incident on a focus point and therefore the spot diameter does not substantially change regardless of the use of the mechanical diaphragm; on the other hand, the light after passing through the outer area causes aberration and therefore the aberration increases without the use of the mechanical diaphragm, compared with the use of it. Accordingly, it is possible to check whether or not the light beam having the wavelength λ1 after transmitting through the outer area becomes flare by examining the change in spot diameter and aberration.

### EXAMPLE 1

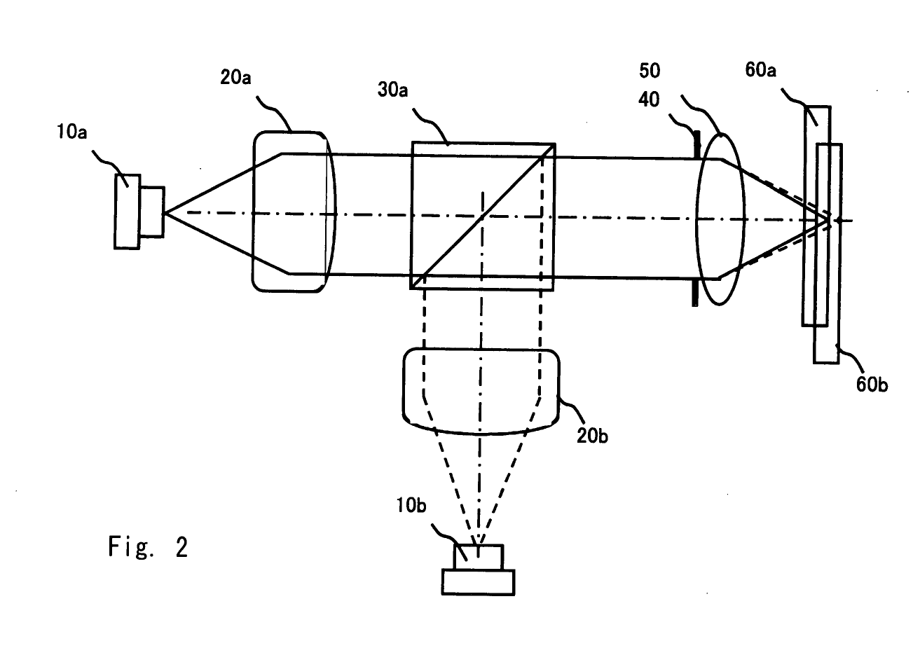

The above embodiment is described hereinafter in detail with reference to the drawings, using the example of two kinds of optical disks, HD DVD (λ1=405 nm, NA=0.65, transparent substrate thickness 0.6 mm) and DVD (λ2=660 nm, NA=0.65, transparent substrate thickness 0.6 mm). FIG. 2 schematically shows the structure of an optical pickup apparatus according to Example 1 of the present invention.

The optical pickup apparatus of FIG. 2 includes a HD DVD laser 10a that emits a light beam with a wavelength of 405 nm, a DVD laser 10b that emits a light beam with a wavelength of 660 nm, collimator lenses 20a and 20b, abeam splitter 30a, a diaphragm 40, an objective lens 50, an HD DVD disk 60a, and a DVD disk 60b.

The light beams emitted by the lasers 10a and 10b respectively pass through the collimator lenses 20a and 20b to become substantially parallel light and then enter the beam splitter 30a to be directed to a common optical path. After that, the light beams pass through the diaphragm 40 to have the same light beam diameter and then enter the objective lens 50. The light beams having passed through the objective lens 50 are focused on the information recording surface of the disk 60a or 60b to form a light spot.

The light beams which are reflected on the information recording surface of the disk 60a or 60b again enter the objective lens 50 and are then detected by a detection system (not shown) The detection system photoelectrically converts the detected light beams to thereby generate a focus servo signal, a track servo signal, a reproduction signal and so on.

Table 1 below shows the details of the optical system which sets the objective lenses for HD DVD and DVD as standards.

TABLE 1

| | | | | | |
|---|---|---|---|---|---|
| | | INTERPLANAR | | | |
| | | DISTANCE | | | |
| | CURVATURE | ON | MATERIAL | | EFFECTIVE |
| | RADIUS | OPTICAL AXIS | BETWEEN | REFRACTIVE | DIAMETER |
| PLANE | (mm) | (mm) | PLANES | INDEX | (mm) |

HD DVD OPTICAL SYSTEM (WAVELENGTH 405 nm NA 0.65)

| | | | | | | |
|---|---|---|---|---|---|---|
| 1 | OBJECT SURFACE | ∞ | ∞ | AIR | 1 | — |
| 2 | APERTURE SURFACE | ∞ | 0 | AIR | 1 | 4.169 |
| 3 | LENS SURFACE; | ASPHERICAL | 2.2 | RESIN | 1.5250 | — |
| | OBJECT SIDE | SURFACE | | | | |
| 4 | LENS SURFACE; | ASPHERICAL | 1.5419 | AIR | 1 | — |
| | IMAGE SURFACE SIDE | SURFACE | | | | |
| 5 | DISK SURFACE; | ∞ | 0.6 | PC | 1.6235 | — |
| | OBJECT SIDE | | | | | |
| 6 | DISK INFORMATION | ∞ | — | — | — | — |
| | RECORDING SURFACE | | | | | |

DVD OPTICAL SYSTEM (WAVELENGTH 660 nm NA 0.65)

| | | | | | | |
|---|---|---|---|---|---|---|
| 1 | OBJECT SURFACE | ∞ | ∞ | AIR | 1 | — |
| 2 | APERTURE SURFACE | ∞ | 0 | AIR | 1 | 4.169 |
| 3 | LENS SURFACE; | ASPHERICAL | 2.2 | RESIN | 1.5066 | — |
| | OBJECT SIDE | SURFACE | | | | |
| 4 | LENS SURFACE; | ASPHERICAL | 1.6356 | AIR | 1 | — |
| | IMAGE SURFACE SIDE | SURFACE | | | | |
| 5 | DISK SURFACE; | ∞ | 0.6 | PC | 1.58 | — |
| | OBJECT SIDE | | | | | |
| 6 | DISK INFORMATION | ∞ | — | — | — | — |
| | RECORDING SURFACE | | | | | |

Though the objective lens is made of resin in Example 1, it may be made of glass. However, the material of the objective lens is preferably polyolefin or acrylic resin for their easiness of molding, mass production, and low costs. The polyolefin resin is particularly preferred because a change in refractive index due to water absorption hardly occurs.

Table 2 below shows the detailed specification of the objective lens 50.

TABLE 2

| | HD DVD | DVD |
|---|---|---|
| DESIGN WAVELENGTH λ (nm) | 405 | 660 |
| FOCAL LENGTH f (mm) | 3.102 | 3.207 |
| IMAGE SIDE NUMERICAL APERTURE NA | 0.65 | 0.65 |
| INCIDENT LIGHT BEAM DIAMETER (mm) | 4.169 | 4.169 |
| EFFECTIVE DIAMETER (mm) | 4.032 | 4.169 |
| OBJECT DISTANCE (mm) | ∞ | ∞ |

As shown in Table 2, NA is 0.65 both for HD DVD and DVD. NA is expressed as effective diameter/(2*focal length). In this example, the focal length of HD DVD is less than that of DVD; accordingly, the effective diameter of DVD is larger than that of HD DVD.

Therefore, the objective lens of the embodiment of the invention is designed according to the above-described technique in order that a light beam with the wavelength 405 nm for HD DVD and a light beam with the wavelength 660 nm for DVD both cause less wavefront aberration and that each light beam is focused with appropriate NA under the same incident light beam diameter condition. Specifically, the objective lens has a plurality of loop zones which are formed radially and concentrically about the optical axis. Further, the objective lens has an inner area which includes the optical axis and is composed of one or more loop zones, and an outer area which is located outside the inner area and composed of one or more loop zones. In Example 1, the lens surface of 0 to 2.016 mm, which corresponds to the range within the effective radius of HD DVD, including the optical axis serves as the inner area, and the lens surface of 2.016 to 2.085 mm, which corresponds to the range exceeding the effective radius of HD DVD and within the effective radius of DVD, serves as the outer area. In other words, a HD DVD and DVD common use area is the inner area and a DVD exclusive use area, which is outside the effective diameter of HD DVD, is the outer area.

Table 3 below shows the range of each loop zone and the values of constants C, K, A4, A6, A8, A10, A12, A14, A16 and B in Expression 1 in the objective lens of Example 1.

TABLE 3

| | LOOP ZONE | | | | |
|---|---|---|---|---|---|
| | 1 | 2 | 3 | 4 | 5 |
| C | 0.5051472 | 0.5050189 | 0.5048909 | 0.5047627 | 0.5046351 |
| K | −7.172968E−01 | −7.327047E−01 | −7.206000E−01 | −7.269849E−01 | −7.221079E−01 |
| A4 | 5.789277E−03 | 6.033526E−03 | 5.834311E−03 | 5.933098E−03 | 5.849392E−03 |
| A6 | −3.360124E−04 | −3.195964E−04 | −3.333003E−04 | −3.270737E−04 | −3.307511E−04 |
| A8 | 2.014174E−04 | 2.038318E−04 | 2.034130E−04 | 2.051770E−04 | 2.033857E−04 |
| A10 | −8.138269E−05 | −8.203668E−05 | −8.242272E−05 | −8.313405E−05 | −8.248706E−05 |
| A12 | 2.376820E−05 | 2.399527E−05 | 2.410154E−05 | 2.433058E−05 | 2.414909E−05 |
| A14 | −6.448674E−06 | −6.474313E−06 | −6.484029E−06 | −6.510705E−06 | −6.476666E−06 |
| A16 | 7.395427E−07 | 7.398968E−07 | 7.392000E−07 | 7.395976E−07 | 7.362661E−07 |
| B | 0 | −0.001453 | −0.002906 | −0.004359 | −0.005811 |
| POSITION | 0.000 | 0.521 | 0.775 | 1.008 | 1.265 |
| (INNER SIDE) | | | | | |
| (mm) | | | | | |
| POSITION | 0.521 | 0.775 | 1.008 | 1.265 | 1.772 |
| (OUTER | | | | | |
| SIDE) | | | | | |
| (mm) | | | | | |
| | LOOP ZONE | | | | |
| | 6 | 7 | 8 | 9 | 10 |
| C | 0.5047629 | 0.5048909 | 0.5050191 | 0.5051472 | 0.5035343 |
| K | −7.269067E−01 | −7.189151E−01 | −7.288812E−01 | −7.209824E−01 | −7.156888E−01 |
| A4 | 5.931628E−03 | 5.807466E−03 | 5.971796E−03 | 5.848637E−03 | 5.749208E−03 |
| A6 | −3.267304E−04 | −3.357528E−04 | −3.234992E−04 | −3.317043E−04 | −3.276012E−04 |
| A8 | 2.047551E−04 | 2.037860E−04 | 2.032714E−04 | 2.016531E−04 | 2.042765E−04 |
| A10 | −8.291712E−05 | −8.269543E−05 | −8.191446E−05 | −8.133758E−05 | −8.072747E−05 |
| A12 | 2.426782E−05 | 2.417751E−05 | 2.395644E−05 | 2.376216E−05 | 2.413636E−05 |
| A14 | −6.501300E−06 | −6.495586E−06 | −6.469063E−06 | −6.447540E−06 | −6.454804E−06 |
| A16 | 7.390262E−07 | 7.398984E−07 | 7.395842E−07 | 7.394927E−07 | 7.282451E−07 |
| B | −0.004362 | −0.002910 | −0.001456 | 0 | 0 |
| POSITION | 1.772 | 1.872 | 1.933 | 1.980 | 2.016 |
| (INNER SIDE) | | | | | |
| (mm) | | | | | |
| POSITION | 1.872 | 1.933 | 1.980 | 2.016 | 2.085 |
| (OUTER | | | | | |
| SIDE) (mm) | | | | | |

LENS IMAGE SURFACE SIDE

| | |
|---|---|
| C | −0.176198943 |
| K | −5.506429E+01 |
| A4 | 4.689891E−03 |
| A6 | −2.015207E−03 |
| A8 | −1.091107E−04 |
| A10 | 1.343906E−04 |
| A12 | 7.694800E−06 |
| A14 | −8.013337E−06 |
| A16 | 8.706881E−07 |

In Table 3, the loop zones 1 to 9 (0 to 2.016 mm) correspond to the inner area, and the loop zone 10 (2.016 to 2.085 mm) corresponds to the outer area.

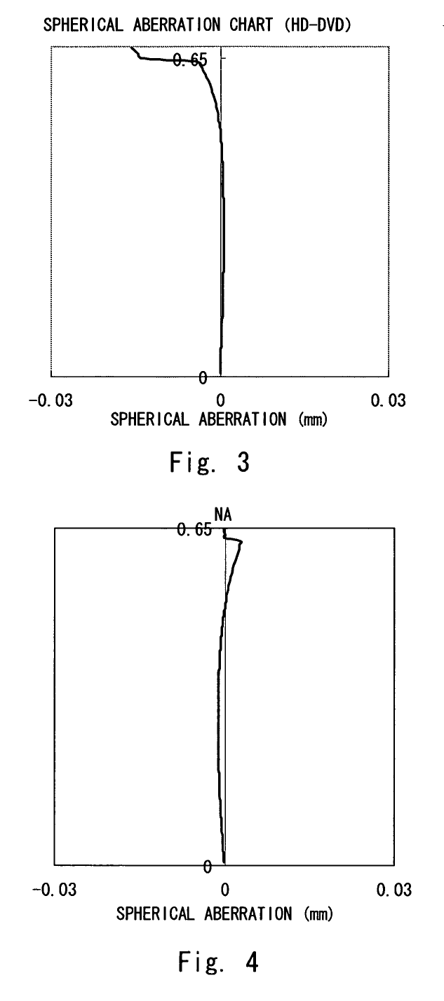

FIG. 3 shows a chart of spherical aberration for HD DVD according to Example 1. FIG. 4 shows a chart of spherical aberration for DVD according to Example 1. As shown in FIG. 4, for the light beam with DVD wavelength of 660 nm, aberration is corrected for all apertures up to NA 0.65. In Example 1, regarding DVD, the range of NA 0.63 to NA 0.65 corresponds to the outer area, and spherical aberration is relatively low in the exclusive use area which is used only for DVD.

On the other hand, as shown in FIG. 3, for the light beam with HD DVD wavelength of 405 nm, aberration is corrected within NA 0.65, which is an actual use range corresponding to the inner area, but large spherical aberration occurs in the part outside NA 0.65 which corresponds to the outer area to cause flare to appear. Therefore, the light beam with HD DVD wavelength of 405 nm is not focused if NA exceeds 0.65 and thus does not form the light spot; as a result, an appropriate light spot with NA 0.65 can be obtained. Specifically, regarding the light beam with HD DVD wavelength of 405 nm, the light beam which reaches the information recording surface of an optical disk after passing through the inner area is focused on the information recording surface, while the light beam which reaches the information recording surface of an optical disk after passing through the outer area is not focused on the information recording surface.

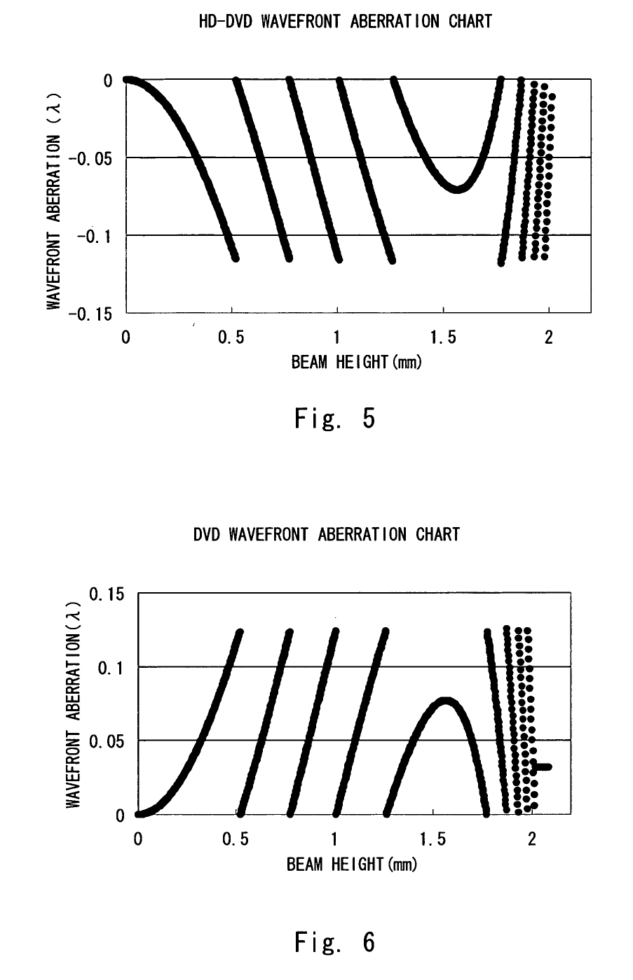

FIG. 5 shows a chart of wavefront aberration for HD DVD according to Example 1. FIG. 6 shows a chart of wavefront aberration for DVD according to Example 1. The wavefront aberration is 0.13λ or lower for both HD DVD and DVD. RMS wavefront aberration is 0.0303 λrms for HD DVD and 0.0316 λrms for DVD. These values are well below the Marechal Criterion 0.070 λrms that is a wavefront aberration limit, and the wavefront aberration is reduced sufficiently.

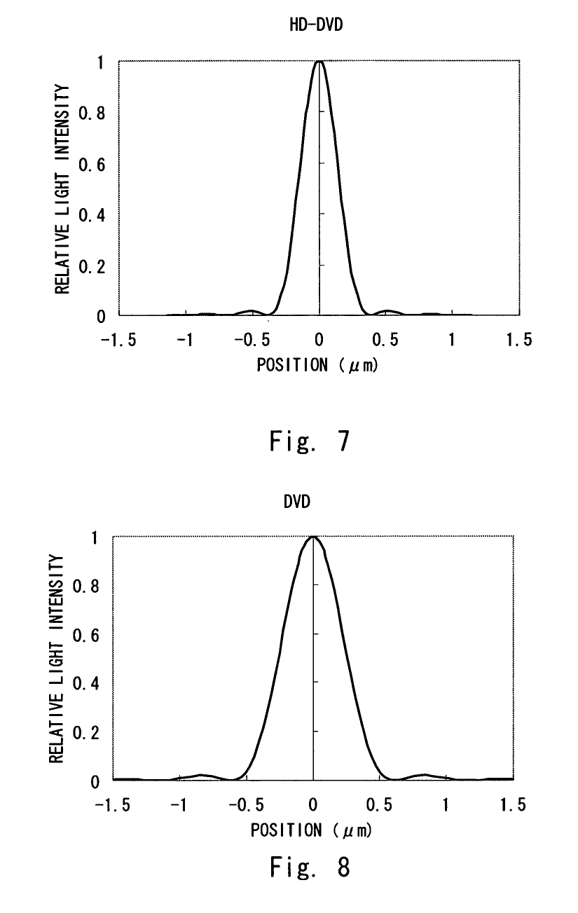

FIGS. 7 and 8 are graphs showing the light spot for the cases of HD DVD and DVD in Example 1. The diameter of the light spot having a relative light intensity of 1/e² (=0.135) is 0.519 μm for HD DVD and 0.838 μm for DVD. The light spot diameter is approximately 0.82*wavelength/NA in an ideal optical system with no aberration. In an actual lens, the light spot diameter is preferably about 0.9 to 1.02 times the value of 0.82*wavelength/NA. Too large light spot diameter causes adverse effects such as super-resolution, and too large light spot diameter causes deteriorated focusing characteristics of the light spot to adversely affect jitter characteristics or the like. In Example 1, in HD DVD (wavelength 405 nm, NA 0.65), the value of 0.82*wavelength/NA is 0.511 μm and an actual light spot diameter is 0.519 μm, which is 1.015 times the above value. In DVD (wavelength 660 nm, NA 0.65), the value of 0.82*wavelength/NA is 0.832 μm and an actual light spot diameter is 0.838 μm, which is 1.007 times the above value. The actual light spot diameters are within the preferred range, which means that a suitable light spot is formed for both HD DVD and DVD.

Table 4 below shows a difference in optical path length of light beams which pass through each loop zone in the objective lens 50 according to Example 1.

TABLE 4

| | OPTICAL PATH LENGTH DIFFERENCE | |
|---|---|---|
| | FROM FIRST LOOP ZONE (λ) | |
| LOOP | WAVELENGTH 405 nm, | |
| ZONE | HDDVD | WAVELENGTH 660 nm, DVD |
| 1 | REFERENCE | REFERENCE |
| 2 | ABOUT 2 | ABOUT 1 |
| 3 | ABOUT 4 | ABOUT 2 |
| 4 | ABOUT 6 | ABOUT 3 |
| 5 | ABOUT 8 | ABOUT 4 |
| 6 | ABOUT 6 | ABOUT 3 |
| 7 | ABOUT 4 | ABOUT 2 |
| 8 | ABOUT 2 | ABOUT 1 |
| 9 | ABOUT 0 | ABOUT 0 |
| 10 | ABOUT 0 | ABOUT 0 |

The lens is designed so that a difference in substantial optical path length between a light beam which passes through the second to tenth loop zone and a light beam which passes through the first loop zone is about nλ (n is an integral number) for DVD wavelength 660 nm and about 2mλ (m is an integral number) for HD DVD wavelength 405 nm.

### EXAMPLE 2

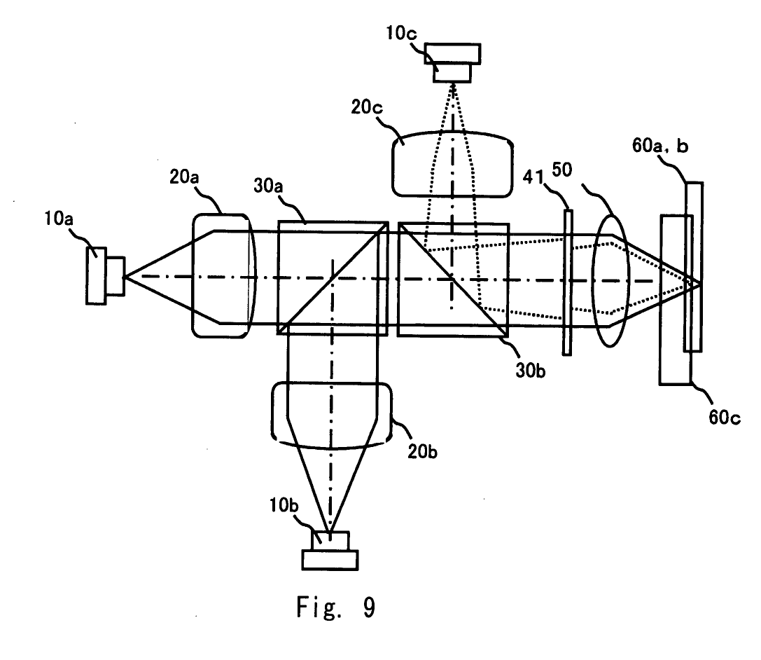

The optical pickup apparatus according to Example 2 is compatible with three kinds of optical disks: HD DVD (λ1=405 nm, NA=0.65, transparent substrate thickness 0.6 mm), DVD (λ2=660 nm, NA=0.65, transparent substrate thickness 0.6 mm), and CD (λ3=785 nm, NA=0.50, transparent substrate thickness 1.2 mm). FIG. 9 schematically shows the structure of an optical pickup apparatus according to Example 2.

The optical pickup apparatus of FIG. 9 includes a HD DVD laser 10a that emits a light beam with a wavelength of 405 nm, a DVD laser 10b that emits a light beam with a wavelength of 660 nm, a CD laser 10c that emits a light beam with a wavelength of 785 nm, collimator lenses 20a, 20b and 20c, beam splitters 30a and 30b, an aperture limiting element 41, an objective lens 50, a HD DVD disk 60a, a DVD disk 60b, and a CD disk 60c.

The light beams emitted by the lasers 10a and 10b respectively pass through the collimator lenses 20a and 20b to become substantially parallel light and then enter the beam splitter 30a to be directed to a common optical path. Further, the light beams enter the beam splitter 30b, pass through the aperture limiting element 41 to have the same light beam diameter and then enter the objective lens 50. The light beams having passed through the objective lens 50 are focused on the information recording surface of the disk 60a or 60b to form a light spot.

The light beams which are reflected on the information recording surface of the disk 60a or 60b again enter the objective lens 50 and are then detected by a detection system (not shown). The detection system photoelectrically converts the detected light beams to thereby generate a focus servo signal, a track servo signal, a reproduction signal and so on.

The light beams emitted by the laser 10c passes through the collimator lens 20c where its divergence angle is changed. The light beams then enter the beam splitter 30b, pass through the aperture limiting element 41 to have a different light beam diameter from the light beam emitted by the lasers 10a and 10b, and enter the objective lens 50 as divergent light. The light beams having passed through the objective lens 50 are focused on the information recording surface of the disk 60c to form a light spot.

The light beams which are reflected on the information recording surface of the disk 60c again enter the objective lens 50 and are then detected by a detection system (not shown). The detection system photoelectrically converts the detected light beams to thereby generate a focus servo signal, a track servo signal, a reproduction signal and so on.

Example 2 sets the degree of divergence of only the light beam with CD wavelength entering the objective lens, thereby reducing aberration.

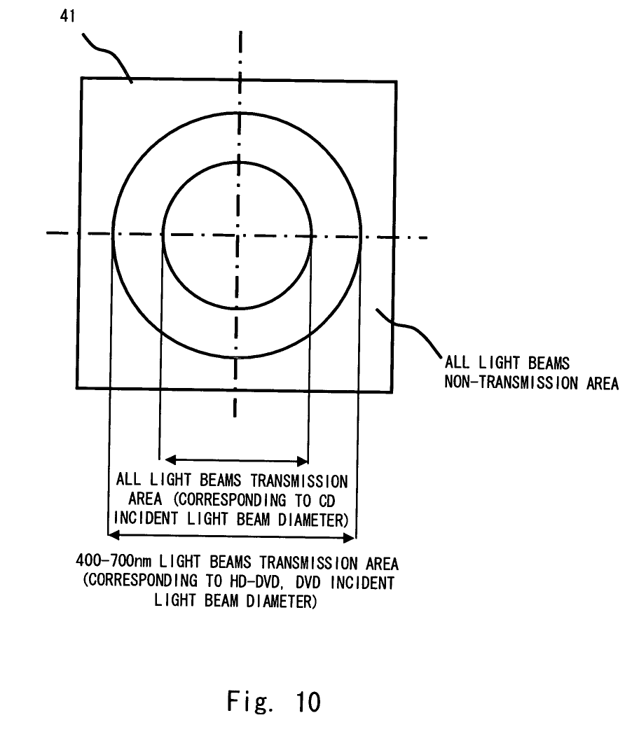

The aperture limiting element 41 may be as shown in FIG. 10. The light beams emitted by the lasers 10a and 10b have the same light beam diameter after passing through the aperture limiting element 41. On the other hand, the light beams emitted by the laser 10c have a different light beam diameter from the light beams emitted by the lasers 10a and 10b after passing through the aperture limiting element 41. In this example, the light beams emitted by the laser 10c has a smaller diameter when entering the objective lens 50 after passing through the aperture limiting element 41 than the light beams emitted by the lasers 10a and 10b. The aperture limiting element 41 may be in the form of a wavelength selection filter placed on the surface of the objective lens 50.

Table 5 below shows the details of the optical system which sets the objective lenses for HD DVD, DVD and CD as standards.

TABLE 5

| | | | | | |
|---|---|---|---|---|---|
| | | INTERPLANAR | | | |
| | | DISTANCE | | | |
| | CURVATURE | ON OPTICAL | MATERIAL | | EFFECTIVE |
| | RADIUS | AXIS | BETWEEN | REFRACTIVE | DIAMETER |
| PLANE | (mm) | (mm) | PLANES | INDEX | (mm) |

HD DVD OPTICAL SYSTEM (WAVELENGTH 405 nm NA 0.65)

| | | | | | | |
|---|---|---|---|---|---|---|
| 1 | OBJECT SURFACE | ∞ | ∞ | AIR | 1 | — |
| 2 | APERTURE | ∞ | 0 | AIR | 1 | 2.688 |
| | SURFACE | | | | | |
| 3 | LENS SURFACE; | ASPHERICAL | 1.34 | RESIN | 1.5250 | — |
| | OBJECT SIDE | SURFACE | | | | |
| 4 | LENS SURFACE; | ASPHERICAL | 0.895 | AIR | 1 | — |
| | IMAGE SURFACE | SURFACE | | | | |
| | SIDE | | | | | |
| 5 | DISK SURFACE; | ∞ | 0.6 | PC | 1.6235 | — |
| | OBJECT SIDE | | | | | |
| 6 | DISK | ∞ | — | — | — | — |
| | INFORMATION | | | | | |
| | RECORDING | | | | | |
| | SURFACE | | | | | |

DVD OPTICAL SYSTEM (WAVELENGTH 660 nm NA 0.65)

| | | | | | | |
|---|---|---|---|---|---|---|
| 1 | OBJECT SURFACE | ∞ | ∞ | AIR | 1 | — |
| 2 | APERTURE | ∞ | 0 | AIR | 1 | 2.688 |
| | SURFACE | | | | | |
| 3 | LENS SURFACE; | ASPHERICAL | 1.34 | RESIN | 1.5066 | — |
| | OBJECT SIDE | SURFACE | | | | |
| 4 | LENS SURFACE; | ASPHERICAL | 0.950 | AIR | 1 | — |
| | IMAGE SURFACE | SURFACE | | | | |
| | SIDE | | | | | |
| 5 | DISK SURFACE; | ∞ | 0.6 | PC | 1.58 | — |
| | OBJECT SIDE | | | | | |
| 6 | DISK | ∞ | — | — | — | — |
| | INFORMATION | | | | | |
| | RECORDING | | | | | |
| | SURFACE | | | | | |

CD OPTICAL SYSTEM (WAVELENGTH 785 nm NA 0.50)

| | | | | | | |
|---|---|---|---|---|---|---|
| 1 | OBJECT SURFACE | ∞ | 25.22 | AIR | 1 | — |
| 2 | APERTURE | ∞ | 0 | AIR | 1 | 2.160 |
| | SURFACE | | | | | |
| 3 | LENS SURFACE; | ASPHERICAL | 1.34 | RESIN | 1.5030 | — |
| | OBJECT SIDE | SURFACE | | | | |
| 4 | LENS SURFACE; | ASPHERICAL | 0.758 | AIR | 1 | — |
| | IMAGE SURFACE | SURFACE | | | | |
| | SIDE | | | | | |
| 5 | DISK SURFACE; | ∞ | 1.2 | PC | 1.5716 | — |
| | OBJECT SIDE | | | | | |
| 6 | DISK | ∞ | — | — | — | — |
| | INFORMATION | | | | | |
| | RECORDING | | | | | |
| | SURFACE | | | | | |

Though the objective lens is made of resin in Example 2, it may be made of glass. However, the material of the objective lens is preferably polyolefin or acrylic resin for their easiness of molding, mass production, and low costs. The polyolefin resin is particularly preferred because a change in refractive index due to water absorption hardly occurs.

Table 6 below shows the detailed specification of the objective lens 50 according to Example 2.

TABLE 6

| | HD DVD | DVD | CD |
|---|---|---|---|
| DESIGN WAVELENGTH λ (nm) | 405 | 660 | 785 |
| FOCAL LENGTH f (mm) | 2.00 | 2.07 | 2.08 |
| IMAGE SIDE NUMERICAL | 0.65 | 0.65 | 0.50 |
| APERTURE NA | | | |
| INCIDENT LIGHT BEAM DIAMETER | 2.688 | 2.688 | 2.160 |
| (mm) | | | |
| EFFECTIVE DIAMETER (mm) | 2.600 | 2.688 | 2.206 |
| OBJECT DISTANCE (mm) | ∞ | ∞ | 25.17 |

As shown in Table 6, an incident light diameter is the same in HD DVD and DVD while an effective diameter is larger in DVD. In Example 2, the lens surface of 0 to 1.300 mm, which corresponds to the range within the effective radius (effective diameter/2) of HD DVD, serves as the inner area, and the lens surface of 1.300 to 1.344 mm, which corresponds to the range exceeding the effective radius of HD DVD and within the effective radius of DVD, serves as the outer area. As for CD, an incident light diameter is matched with the effective diameter by the aperture limiting element. The object distance in CD is determined by optimization for reducing wavefront aberration.

Table 7 below shows the range of each loop zone and the values of constants C, K, A4, A6, A8, A10, A12, A14, A16 and B in Expression 1 in the objective lens of Example 2.

TABLE 7

| LOOP ZONE | 1 | 2 | 3 | 4 |
|---|---|---|---|---|
| C | 0.7958785 | 0.7955609 | 0.7952424 | 0.7955599 |
| K | −2.460135E+00 | −2.485152E+00 | −2.482763E+00 | −2.455935E+00 |
| A4 | 1.230199E−01 | 1.244401E−01 | 1.241447E−01 | 1.226124E−01 |
| A6 | −3.793020E−02 | −3.925786E−02 | −3.904962E−02 | −3.762371E−02 |
| A8 | 2.512017E−02 | 2.610843E−02 | 2.594789E−02 | 2.488492E−02 |
| A10 | −1.486103E−02 | −1.544041E−02 | −1.534205E−02 | −1.471642E−02 |
| A12 | 7.267348E−03 | 7.501751E−03 | 7.456174E−03 | 7.201545E−03 |
| A14 | −2.559006E−03 | −2.613182E−03 | −2.597777E−03 | −2.538312E−03 |
| A16 | 3.858276E−04 | 3.910904E−04 | 3.886588E−04 | 3.827872E−04 |
| B | 0 | −0.001459 | −0.002917 | −0.001460 |
| POSITION | 0.000 | 0.487 | 0.760 | 1.114 |
| (INNER SIDE) (mm) | | | | |
| POSITION | 0.487 | 0.760 | 1.114 | 1.216 |
| (OUTER SIDE) (mm) | | | | |

| LOOP ZONE | 5 | 6 | 7 |
|---|---|---|---|
| C | 0.7958786 | 0.7961976 | 0.7923753 |
| K | −2.454392E+00 | −2.448970E+00 | −2.428427E+00 |
| A4 | 1.226598E−01 | 1.224638E−01 | 1.228802E−01 |
| A6 | −3.760874E−02 | −3.737767E−02 | −3.784265E−02 |
| A8 | 2.487744E−02 | 2.470817E−02 | 2.454938E−02 |
| A10 | −1.471476E−02 | −1.461660E−02 | −1.453811E−02 |
| A12 | 7.205268E−03 | 7.168450E−03 | 7.239365E−03 |
| A14 | −2.543150E−03 | −2.537730E−03 | −2.524210E−03 |
| A16 | 3.840298E−04 | 3.841194E−04 | 3.706277E−04 |
| B | 0.000000 | 0.001457 | 0.000000 |
| POSITION | 1.216 | 1.272 | 1.300 |
| (INNER SIDE) (mm) | | | |
| POSITION | 1.272 | 1.300 | 1.344 |
| (OUTER SIDE) (mm) | | | |

LENS IMAGE SURFACE SIDE

| | |
|---|---|
| C | −0.248641787 |
| K | −1.007939E+01 |
| A4 | 5.747243E−02 |
| A6 | −3.948735E−02 |
| A8 | 1.231142E−02 |
| A10 | −1.520840E−03 |
| A12 | 7.694800E−06 |
| A14 | −8.013337E−06 |
| A16 | 8.706881E−07 |

In Table 7, the loop zones 1 to 6 (0 to 1.300 mm) correspond to the inner area, and the loop zone 7 (1.300 to 1.344 mm) corresponds to the outer area.

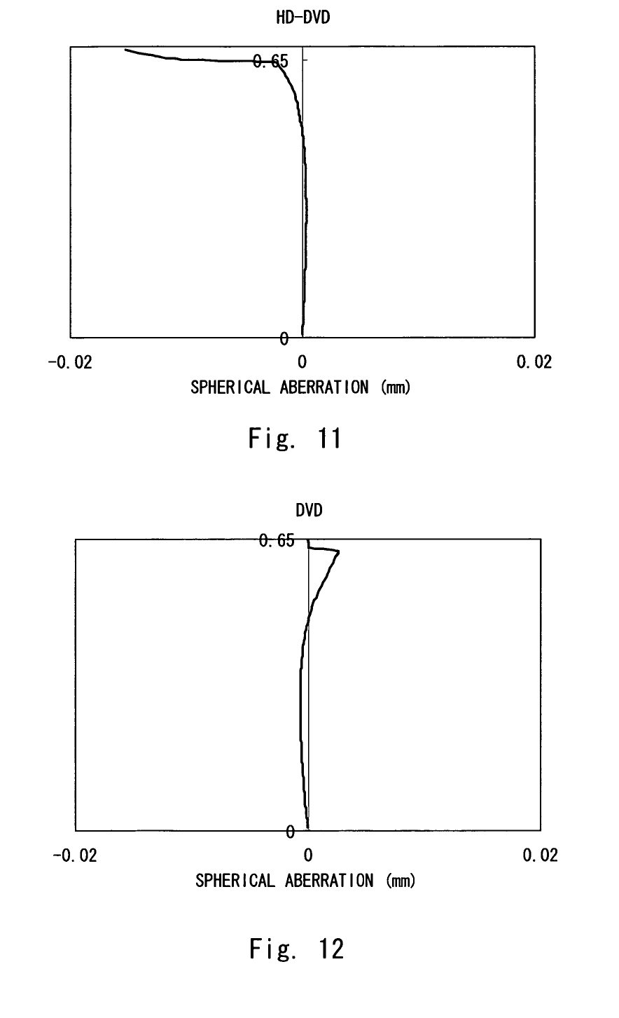

FIG. 11 shows a chart of spherical aberration for HD DVD according to Example 2, FIG. 12 shows that for DVD, and FIG. 13 shows that for CD. As shown in FIG. 12, for the light beam with DVD wavelength of 660 nm, aberration is corrected for all apertures up to NA 0.65 On the other hand, as shown in FIG. 11, for the light beam with HD DVD wavelength of 405 nm, aberration is corrected within NA 0.65, which is an actual use range corresponding to the inner area, but large spherical aberration occurs in the part outside NA 0.65 which corresponds to the outer area to cause flare to appear. Accordingly, an appropriate light spot with NA 0.65 can be obtained by the light beam with the wavelength of 405 nm. Further, for the light beam with CD wavelength of 790 nm, no aberration occurs for all apertures up to NA 0.5. This is because divergent light is incident with an appropriate object distance for CD only.

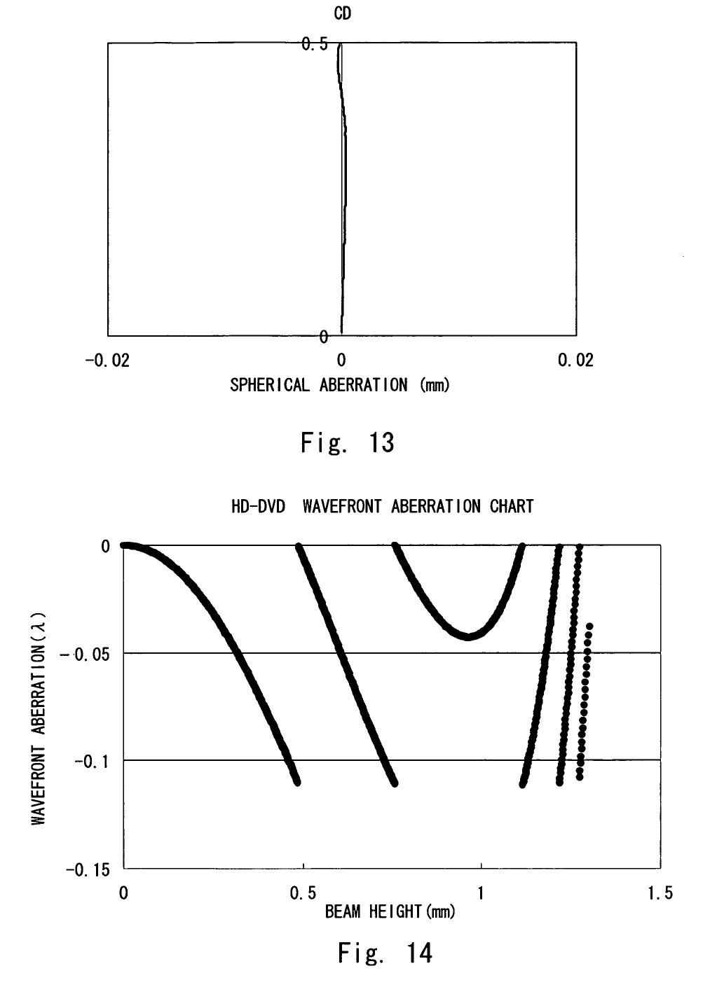

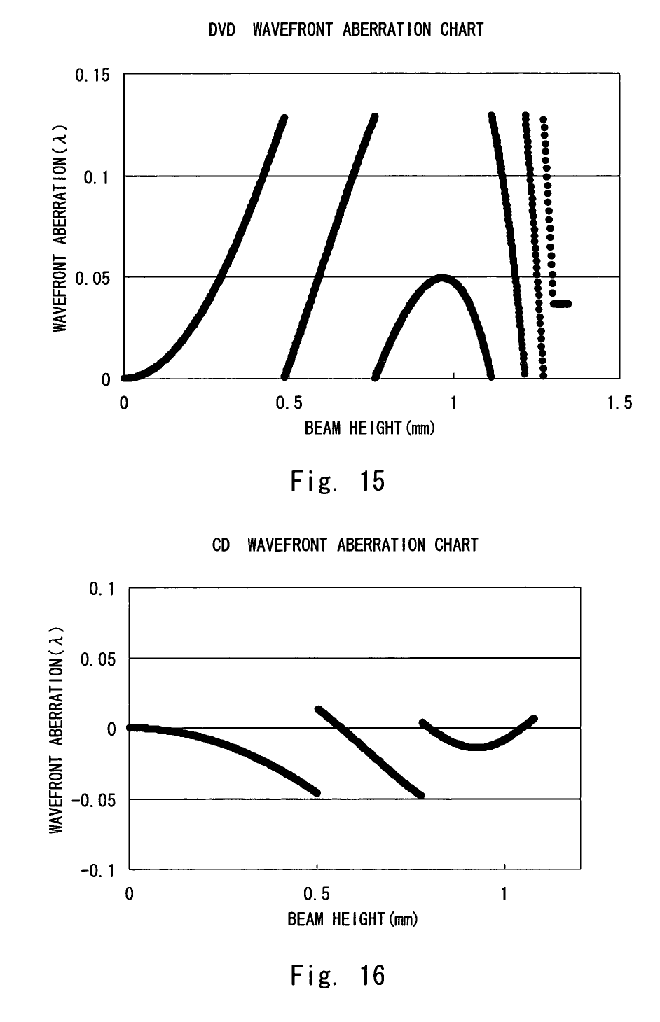

FIGS. 14, 15 and 16 show charts of wavefront aberrations for HD DVD, DVD and CD according to Example 2 The wavefront aberration is 0.013λ or lower for each of HD DVD, DVD and CD. RMS wavefront aberration is 0.0306 λrms for HD DVD, 0.0346 λrms for DVD, and 0.0133 λrms for CD. These values are well below the Marechal Criterion 0.070 λrms that is a wavefront aberration limit, and the wavefront aberration is reduced sufficiently.

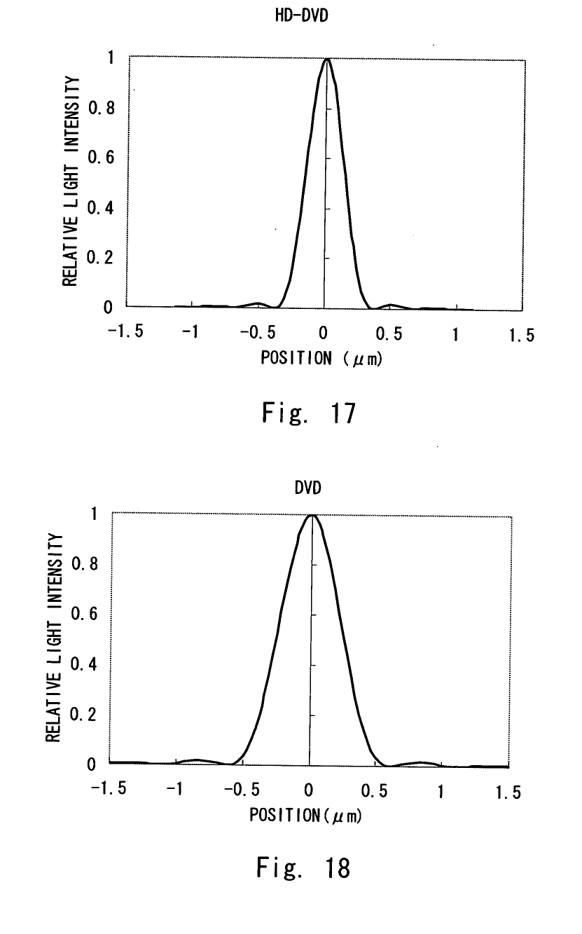

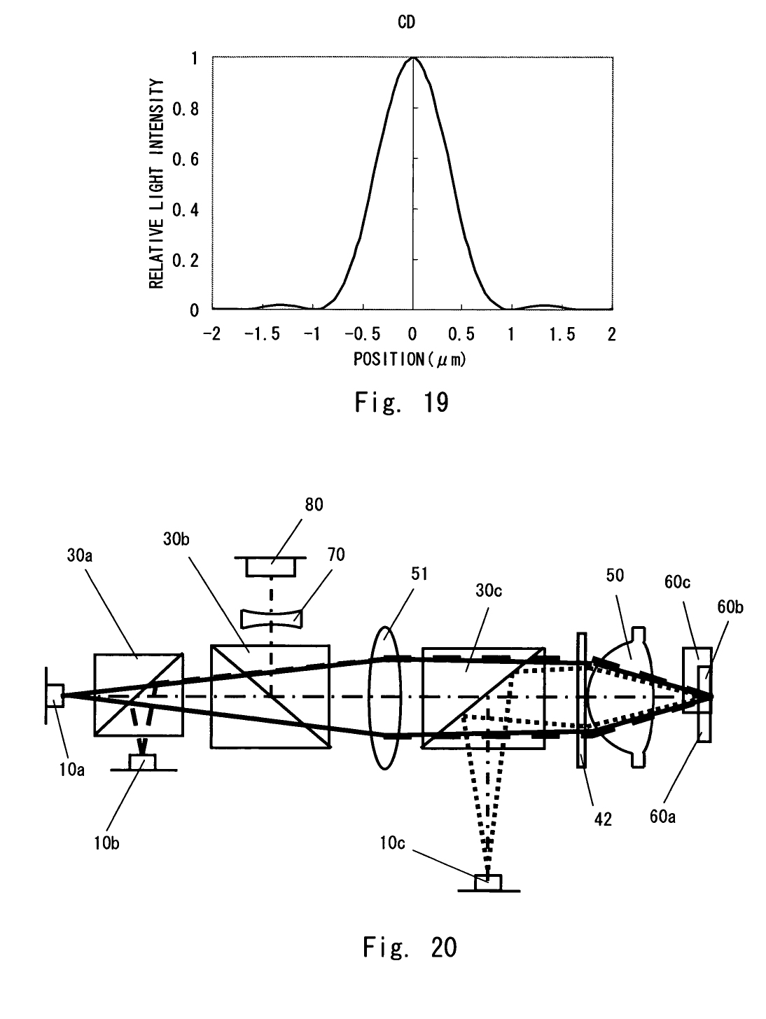

FIGS. 17, 18 and 19 are graphs showing the light spot for the cases of HD DVD, DVD and CD in Example 2. The diameter of the light spot having a relative light intensity of 1/e² (=0.135) is 0.507 μm for HD DVD, 0.828 μm for DVD, and 1.302 μm for CD. Compared with the light spot diameter in an ideal optical system with no aberration, which is 0.82*wavelength/NA, the actual light spot diameters is 0.977 times for HD DVD, 0.988 times for DVD, and 1.011 times for CD. As described above, the light spot diameter is preferably about 0.9 to 1.02 times the value of 0.82*wavelength/NA. The actual light spot diameters are within the preferred range, which means that a suitable light spot is formed for each of HD DVD, DVD and CD.

Table 8 shows light use efficiency of the objective lens according to this Example for each of HD DVD, DVD and CD. The light use efficiency is an integration value of light intensity in 0 order ring of a light spot in the objective lens of this Example when an integration value of light intensity in 0 order ring of a light spot in an ideal lens with no aberration for each of HD DVD, DVD and CD is 100. The 0 order ring corresponds to a peak at the center of a light spot graph.

TABLE 8

| | HD DVD | DVD | CD |
|---|---|---|---|
| LIGHT USE EFFICIENCY (%) | 97.8 | 97.3 | 98.1 |

As shown in Table 8, the objective lens of the present invention achieves high light use efficiency for each of HD DVD, DVD and CD. This is because the objective lens of this invention utilizes refraction only, without utilizing diffraction.

Table 9 below shows a difference in optical path length of light beams which pass through each loop zone in the objective lens 50 according to Example 2.

TABLE 9

| | OPTICAL PATH LENGTH DIFFERENCE | |
|---|---|---|
| | FROM FIRST LOOP ZONE (λ) | |
| LOOP | WAVELENGTH 405 nm, | |
| ZONE | HD DVD | WAVELENGTH 660 nm, DVD |
| 1 | REFERENCE | REFERENCE |
| 2 | ABOUT 2 | ABOUT 1 |
| 3 | ABOUT 4 | ABOUT 2 |
| 4 | ABOUT 2 | ABOUT 1 |
| 5 | ABOUT 0 | ABOUT 0 |
| 6 | ABOUT 2 | ABOUT 1 |
| 7 | ABOUT 0 | ABOUT 0 |

The lens is designed so that a difference in substantial optical path length between a light beam which passes through the second to seventh loop zone and a light beam which passes through the first loop zone is about nλ (n is an integral number) for DVD wavelength 660 nm and about 2mλ (m is an integral number) for HD DVD wavelength 405 nm.

### EXAMPLE 3

The optical pickup apparatus according to Example 3 is compatible with three kinds of optical disks: HD DVD (1=405 nm, NA=0.65, transparent substrate thickness 0.6 mm), DVD (λ2=660 nm, NA=0.65, transparent substrate thickness 0.6 mm), and CD (λ3=785 nm, NA=0.50, transparent substrate thickness 1.2 mm). FIG. 20 schematically shows the structure of an optical pickup apparatus according to Example 3.

The optical pickup apparatus of FIG. 20 includes a HD DVD laser 10a that emits a light beam with a wavelength of 405 nm, a DVD laser 10b, a CD laser/detector module 10c, beam splitters 30a, 30b, 30c, a divergence angle conversion lens 51, an aperture limiting element 42, an objective lens 50, a HD DVD disk 60a, a DVD disk 60b, a CD disk 60c, a detection lens 70, and a HD DVD/DVD photo detector 80.

The light beams emitted by the HD DVD laser 10a and the DVD laser 10b enter the beam splitter 30a to be directed to a common optical path. Further, the light beams enter the beam splitter 30b and pass through the divergence angle conversion lens 51 to become convergent light. Then, the convergent light beams pass through the aperture limiting element 42 and enter the objective lens 50. The light beams having passed through the objective lens 50 are focused on the information recording surface of the HD DVD disk 60a to form a light spot. A distance from the HD DVD laser 10a to the divergence angle conversion lens 51 is set so as to sufficiently reduce aberration for HD DVD. Further, a distance from the DVD laser 10b to the divergence angle conversion lens 51 is set substantially the same as the distance from the HD DVD laser 10a to the divergence angle conversion lens 51, thereby enabling a common use of the photo detector.

The light beams which are reflected on the information recording surface of the HD DVD disk 60a and the DVD disc 60b again pass through the objective lens 50 and enter the beam splitter 30b to change their light path. The redirected light beams pass through the detection lens 70 and are then detected by the HD DVD/DVD photo detector 80. The HD DVD/DVD photo detector 80 photoelectrically converts the detected light beams to thereby generate a focus servo signal, a track servo signal, a reproduction signal and so on.

As for CD, the light beams emitted by the CD laser/detector module 10c enter the beam splitter 30c to be directed to a common optical path to HDDVD and DVD. Then, the light beams pass through the aperture limiting element 42 and enter the objective lens 50 as divergent light. The light beams having passed through the objective lens 50 are focused on the information recording surface of the CD disk 60c to form a light spot. The position of the CD laser/detector module 10c is set so as to sufficiently reduce aberration for CD.

The light beams which are reflected on the information recording surface of the CD disk 60c again pass through the objective lens 50 and enter the beam splitter 30c to change their light path. The redirected light beams are detected by the CD laser/detector module 10c. The CD laser/detector module 10c photoelectrically converts the detected light beams to thereby generate a focus servo signal, a track servo signal, a reproduction signal and so on.

Example 3 changes the light beam with HD DVD wavelength and DVD wavelength into convergent light while setting the degree of divergence to the incident light beam with CD wavelength entering the objective lens, thereby reducing aberration.

The aperture limiting element 42 may be the same as the one used in Example 2. Table 10 below shows the details of the optical system which sets the objective lenses for HD DVD, DVD and CD as standards.

TABLE 10

| | | | | | |
|---|---|---|---|---|---|
| | | INTERPLANAR | | | |
| | | DISTANCE | | | |
| | CURVATURE | ON OPTICAL | MATERIAL | | EFFECTIVE |
| | RADIUS | AXIS | BETWEEN | REFRACTIVE | DIAMETER |
| PLANE | (mm) | (mm) | PLANES | INDEX | (mm) |

HD DVD 405 nm NA 0.65

| | | | | | | |
|---|---|---|---|---|---|---|
| 1 | OBJECT SURFACE | ∞ | −70.0 | AIR | 1 | — |
| 2 | APERTURE | ∞ | 0 | AIR | 1 | 2.587 |
| | SURFACE | | | | | |
| 3 | LENS SURFACE; | ASPHERICAL | 1.34 | RESIN | 1.5248 | — |
| | OBJECT SIDE | SURFACE | | | | |
| 4 | LENS SURFACE; | ASPHERICAL | 0.8110 | AIR | 1 | — |
| | IMAGE SURFACE | SURFACE | | | | |
| | SIDE | | | | | |
| 5 | DISK SURFACE; | ∞ | 0.6 | PC | 1.62 | — |
| | OBJECT SIDE | | | | | |
| 6 | DISK | ∞ | — | — | — | — |
| | INFORMATION | | | | | |
| | RECORDING | | | | | |
| | SURFACE | | | | | |

DVD 658 nm NA 0.65

| | | | | | | |
|---|---|---|---|---|---|---|
| 1 | OBJECT SURFACE | ∞ | −70.0 | AIR | 1 | — |
| 2 | APERTURE | ∞ | 0 | AIR | 1 | 2.587 |
| | SURFACE | | | | | |
| 3 | LENS SURFACE; | ASPHERICAL | 1.34 | RESIN | 1.5067 | — |
| | OBJECT SIDE | SURFACE | | | | |
| 4 | LENS SURFACE; | ASPHERICAL | 0.8609 | AIR | 1 | — |
| | IMAGE SURFACE | SURFACE | | | | |
| | SIDE | | | | | |
| 5 | DISK SURFACE; | ∞ | 0.6 | PC | 1.58 | — |
| | OBJECT SIDE | | | | | |
| 6 | DISK | ∞ | — | — | — | — |
| | INFORMATION | | | | | |
| | RECORDING | | | | | |
| | SURFACE | | | | | |

CD 785 nm NA 0.47

| | | | | | | |
|---|---|---|---|---|---|---|
| 1 | OBJECT SURFACE | ∞ | 32.8 | AIR | 1 | — |
| 2 | APERTURE | ∞ | 0 | AIR | 1 | 1.99 |
| | SURFACE | | | | | |
| 3 | LENS SURFACE; | ASPHERICAL | 1.34 | RESIN | 1.5034 | — |
| | OBJECT SIDE | SURFACE | | | | |
| 4 | LENS SURFACE; | ASPHERICAL | 0.6808 | AIR | 1 | — |
| | IMAGE SURFACE | SURFACE | | | | |
| | SIDE | | | | | |
| 5 | DISK SURFACE; | ∞ | 1.2 | PC | 1.573 | — |
| | OBJECT SIDE | | | | | |
| 6 | DISK | ∞ | — | — | — | — |
| | INFORMATION | | | | | |
| | RECORDING | | | | | |
| | SURFACE | | | | | |

Though the objective lens is made of resin in Example 3, it may be made of glass. However, the material of the objective lens is preferably polyolefin or acrylic resin for their easiness of molding, mass production, and low costs. The polyolefin resin is particularly preferred because a change in refractive index due to water absorption hardly occurs.

Table 11 below shows the detailed specification of the objective lens 50 according to Example 3.

TABLE 11

| | HD DVD | DVD | CD |
|---|---|---|---|
| DESIGN WAVELENGTHλ (nm) | 405 | 658 | 785 |
| FOCAL LENGTH f (mm) | 1.973 | 2.038 | 2.051 |
| IMAGE SIDE NUMERICAL | 0.65 | 0.65 | 0.47 |
| APERTURE NA | | | |
| INCIDENT LIGHT BEAM | 2.587 | 2.587 | 1.99 |
| DIAMETER mm) | | | |
| EFFECTIVE DIAMETER (mm) | 2.483 | 2.557 | 2.018 |
| OBJECT DISTANCE (mm) | −70.0 | −70.0 | 32.76 |

As shown in Table 11, an incident light diameter is the same in HD DVD and DVD while an effective diameter is larger in DVD. In Example 3, the lens surface of 0 to 1.242 mm, which corresponds to the range within the effective radius (effective diameter/2) of HD DVD, serves as the inner area, and the lens surface of 1.242 to 1.279 mm, which corresponds to the range exceeding the effective radius of HD DVD and within the effective radius of DVD, serves as the outer area. As for CD, an incident light diameter is matched with the effective diameter by the aperture limiting element as described earlier. The value of the object distance in CD is determined by optimization for reducing wavefront aberration.

Table 12 below shows the range of each loop zone and the values of constants C, K, A4, A6, A8, A10, A12, A14, A16 and B in Expression 1 in the objective lens of Example 3.

TABLE 12

| | ZONE | | | | |
|---|---|---|---|---|---|
| | 1 | 2 | 3 | 4 | 5 |
| C | 0.8085246 | 0.8081738 | 0.8085240 | 0.8088740 | 0.8092379 |
| K | −2.787126E+00 | −2.768193E+00 | −2.770266E+00 | −2.764056E+00 | −2.759933E+00 |
| A4 | 1.570297E−01 | 1.555869E−01 | 1.559239E−01 | 1.557174E−01 | 1.521705E−01 |
| A6 | −6.655046E−02 | −6.502734E−02 | −6.532210E−02 | −6.501705E−02 | −6.028654E−02 |
| A8 | 5.174151E−02 | 5.031710E−02 | 5.061125E−02 | 5.035715E−02 | 4.795173E−02 |
| A10 | −3.187942E−02 | −3.084531E−02 | −3.106934E−02 | −3.090294E−02 | −3.036962E−02 |
| A12 | 1.654838E−02 | 1.601787E−02 | 1.614713E−02 | 1.608416E−02 | 1.606854E−02 |
| A14 | −5.444929E−03 | −5.280797E−03 | −5.326713E−03 | −5.316324E−03 | −5.319726E−03 |
| A16 | 7.892893E−04 | 7.667904E−04 | 7.739340E−04 | 7.738033E−04 | 7.754593E−04 |
| B | 0.000000 | −0.001457 | −0.000013 | 0.001430 | 0.002970 |
| LOWER | 0.000 | 0.504 | 1.126 | 1.209 | 1.242 |
| LIMIT OF h | | | | | |
| UPPER | 0.504 | 1.126 | 1.209 | 1.242 | 1.279 |
| LIMIT OF h | | | | | |

LENS SURFACE; IMAGE SURFACE SIDE

| | |
|---|---|
| C | −0.251180426 |
| K | −6.439719E+01 |
| A4 | −8.842011E−03 |
| A6 | 5.088087E−02 |
| A8 | −5.121088E−02 |
| A10 | 2.302026E−02 |
| A12 | −4.023199E−03 |
| A14 | 0.000000E+00 |
| A16 | 0.000000E+00 |

In Table 12, the loop zones 1 to 4 (0 to 1.242 mm) correspond to the inner area, and the loop zone 5 (1.242 to 1.279 mm) corresponds to the outer area.

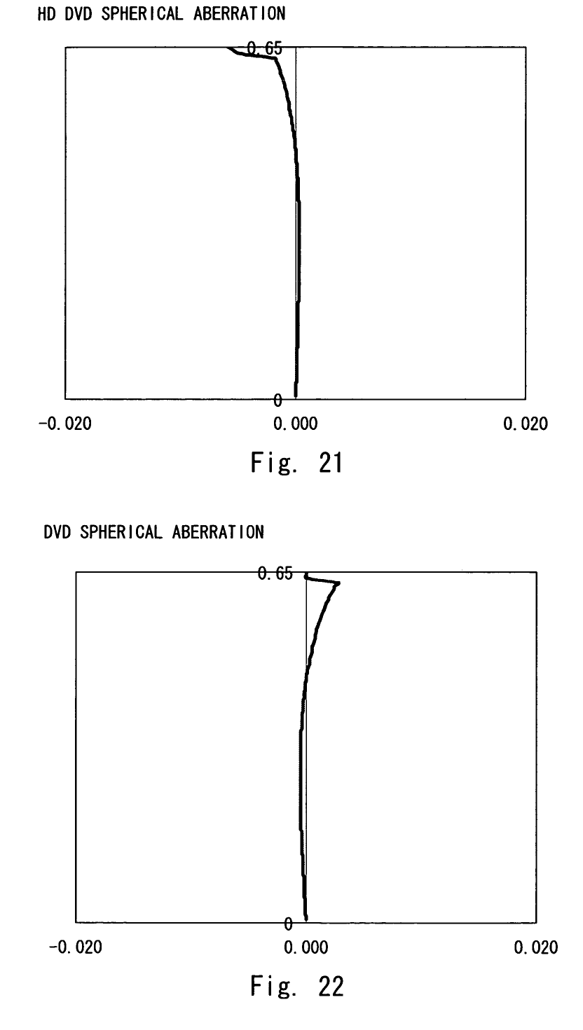

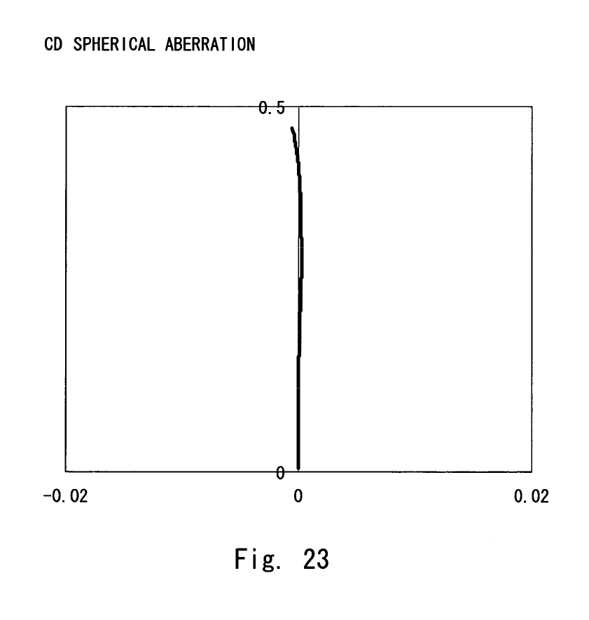

FIG. 21 shows a chart of spherical aberration for HD DVD according to Example 3, FIG. 22 shows that for DVD, and FIG. 13 shows that for CD. As shown in FIG. 22, for the light beam with DVD wavelength of 660 nm, aberration is corrected for all apertures up to NA 0.65. On the other hand, as shown in FIG. 21, for the light beam with HD DVD wavelength of 405 nm, aberration is corrected within NA 0.65, which is an actual use range corresponding to the inner area, but large spherical aberration occurs in the part outside NA 0.65 which corresponds to the outer area to cause flare to appear. Accordingly, an appropriate light spot with NA 0.65 can be obtained by the light beam with the wavelength of 405 nm. Further, for the light beam with CD wavelength of 790 nm, no aberration occurs for all apertures up to NA 0.5. This is because divergent light is incident with an appropriate object distance for CD only.

In Example 3, the wavefront aberration is 0.03357 (λrms) for HD DVD, 0.03639 (λrms) for DVD, and 0.01420 (λrms) for CD. These values are well below the Marechal Criterion 0.070 λrms that is a wavefront aberration limit, and the wavefront aberration is reduced sufficiently.

Table 13 below shows a difference in optical path length of light beams which pass through each loop zone in the objective lens 50 according to Example 3.

TABLE 13

| | OPTICAL PATH LENGTH DIFFERENCE | |
|---|---|---|
| | FROM FIRST LOOP ZONE (λ) | |
| LOOP | WAVELENGTH 405 nm, | |
| ZONE | HD DVD | WAVELENGTH 660 nm, DVD |
| 1 | REFERENCE | REFERENCE |
| 2 | ABOUT 2 | ABOUT 1 |
| 3 | ABOUT 0 | ABOUT 0 |
| 4 | ABOUT 2 | ABOUT 1 |
| 5 | — | ABOUT 2 |

The lens is designed so that a difference in substantial optical path length between a light beam which passes through the second to fifth loop zone and a light beam which passes through the first loop zone is about nλ (n is an integral number) for DVD wavelength 660 nm and about 2mλ (m is an integral number) for HD DVD wavelength 405 nm.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An objective lens that focuses a first light beam with a wavelength λ1 on an information recording surface of a first optical recording medium and focuses a second light beam with a wavelength λ2 being longer than the wavelength λ1 on an information recording surface of a second optical recording medium, comprising:
at least one lens surface being divided into a plurality of ring-shaped zones concentric about an optical axis and including an inner area composed of a part of the plurality of zones and including the optical axis and an outer area composed of a part of the plurality of zones and located outside the inner area,
the inner area focusing the first light beam on the information recording surface of the first optical recording medium and focusing the second light beam on the information recording surface of the second optical recording medium, and
the outer area causing the first light beam to become flare and focusing the second light beam on the information recording surface of the second optical recording medium.

2. The objective lens according to claim 1, wherein each of the plurality of zones has a different aspherical shape.

3. The objective lens according to claim 1, wherein the light beam with the wavelength λ1 and the light beam with the wavelength λ2 are incident on the objective lens with a substantially same diameter.

4. The objective lens according to claim 1, wherein the light beam with the wavelength λ1 and the light beam with the wavelength λ2 are incident on the objective lens in substantially parallel.

5. The objective lens according to claim 1, wherein the light beam with the wavelength λ1 and the light beam with the wavelength λ2 are incident on the objective lens as convergent light beams.

6. The objective lens according to claim 1, wherein the objective lens has a positive power to focus each light beam by refraction.

7. The objective lens according to claim 1, wherein a difference in optical path length between a ray of the light beam with the wavelength λ1 passing through a ring-shaped zone in the inner area and a ray of the light beam with the wavelength λ1 passing through an adjacent ring-shaped zone in the inner area is substantially 2mλ1 where m is an integral number.

8. The objective lens according to claim 7, wherein a difference in optical path length between a ray of the light beam with the wavelength λ2 passing through a ring-shaped zone in the inner area and a ray of the light beam with the wavelength λ2 passing through an adjacent ring-shaped zone in the inner area is substantially 2nλ2 where n is an integral number.

9. The objective lens according to claim 1, wherein a third light beam with a wavelength λ3 (λ1<λ2<λ3) incident as divergent light is focused on an information recording surface of a third optical recording medium.

10. The objective lens according to claim 1, wherein the wavelength λ1 is substantially 405 nm, and the wavelength λ2 is substantially 660 nm.

11. The objective lens according to claim 9, wherein the wavelength λ3 is substantially 785 nm.

12. The objective lens according to claim 1, wherein an effective diameter for the first light beam is smaller than an effective diameter for the second light beam.

13. An objective lens that focuses a first light beam with a wavelength λ1 on an information recording surface of a first optical recording medium, focuses a second light beam with a wavelength λ2 being longer than the wavelength λ1 on an information recording surface of a second optical recording medium, and focuses a third light beam with a wavelength λ3 being longer than the wavelength λ2 on an information recording surface of a third optical recording medium, comprising:
at least one lens surface being divided into a plurality of ring-shaped zones concentric about an optical axis and including a first inner area composed of a part of the plurality of zones and including the optical axis and a second inner area composed of a part of the plurality of zones and located outside the first inner area,
the first inner area focusing the first light beam on the information recording surface of the first optical recording medium, focusing the second light beam-on the information recording surface of the second optical recording medium, and focusing the third light beam on the information recording surface of the third optical recording medium,
the second inner area focusing the first light beam on the information recording surface of the first optical recording medium and focusing the second light beam on the information recording surface of the second optical recording medium,
the outer area causing the first light beam to become flare and focusing the second light beam on the information recording surface of the second optical recording medium, and
the third light beam passing through the second inner area and the outer area being controlled not to be focused on the information recording surface of the third optical recording medium.

14. The objective lens according to claim 13, further comprising:
an aperture limiting device for limiting incidence of the third light beam on the second inner area and the outer area, to control the third light beam passing through the second inner area and the outer area not to be focused on the information recording surface of the third optical recording medium.

15. The objective lens according to claim 13, wherein the second inner area and the outer area cause the third light beam to become flare to control the third light beam passing through the second inner area and the outer area not to be focused on the information recording surface of the third optical recording medium.

16. An optical pickup apparatus comprising:
a first laser for emitting a first light beam with a wavelength λ1;
a second laser for emitting a second light beam with a wavelength λ2 being longer than the wavelength λ1; and
an objective lens for focusing the first light beam emitted by the first laser on an information recording surface of a first optical recording medium and focusing the second light beam emitted by the second laser on an information recording surface of a second optical recording medium, at least one lens surface of the objective lens being divided into a plurality of ring-shaped zones concentric about an optical axis and including an inner area composed of a part of the plurality of zones and including the optical axis and an outer area composed of a part of the plurality of zones and located outside the inner area, the inner area focusing the first light beam on the information recording surface of the first optical recording medium and focusing the second light beam on the information recording surface of the second optical recording medium, and the outer area causing the first light beam to become flare and focusing the second light beam on the information recording surface of the second optical recording medium.

17. The optical pickup apparatus according to claim 16, wherein each of the plurality of zones on the objective lens has a different aspherical shape.

18. The optical pickup apparatus according to claim 16, further comprising:
a third laser for emitting a third light beam with a wavelength λ3 (λ1<λ2<λ3) incident on the objective lens as divergent light,
wherein the objective lens focuses the third light beam on an information recording surface of a third optical recording medium.

19. The optical pickup apparatus according to claim 16, wherein the objective lens has a positive power to focus each light beam by refraction.

20. The optical pickup apparatus according to claim 16, wherein, in the objective lens, a difference in optical path length between a ray of the light beam with the wavelength λ1 passing through a ring-shaped zone in the inner area and a ray of the light beam with the wavelength λ1 passing through an adjacent ring-shaped zone in the inner area is substantially 2mλ1 where m is an integral number.

21. The optical pickup apparatus according to claim 20, wherein a difference in optical path length between a ray of the light beam with the wavelength λ2 passing through a ring-shaped zone in the inner area and a ray of the light beam with the wavelength λ2 passing through an adjacent ring-shaped zone in the inner area is substantially 2nλ2 where n is an integral number.

22. The optical pickup apparatus according to claim 16, wherein the wavelength λ1 is substantially 405 nm, and the wavelength λ2 is substantially 660 nm.

23. The optical pickup apparatus according to claim 18, wherein the wavelength λ3 is substantially 785 nm.

24. The optical pickup apparatus according to claim 16, wherein an effective diameter for the first light beam is smaller than an effective diameter for the second light beam.
